(19) United States
(12) Patent Application Publication
(10) Pub. No.: US 2020/0125067 A1
(43) Pub. Date: Apr. 23, 2020

(54) SYSTEM FOR MACHINING WORKPIECES

(71) Applicant: HOMAG Bohrsysteme GmbH, Herzebrock-Clarholz (DE)

(72) Inventors: Benjamin WIND, Detmold (DE); Boris ROETTGEN, Langenberg (DE); Gregor GLOMM, Rheda-Wiedenbrueck (DE)

(21) Appl. No.: 16/604,551

(22) PCT Filed: May 8, 2018
(86) PCT No.: PCT/EP2018/061811

§ 371 Date: Oct. 10, 2019

(30) Foreign Application Priority Data
May 11, 2017 (DE) 10 2017 208 009.4

(51) Int. Cl. G05B 19/4093; G06F 3/01

(52) U.S. Cl. CPC G05B 19/4093; G06F 3/011; G05B 2219/23148; G05B 2219/32014; G06F 3/016

(57) ABSTRACT

The invention relates to a system (1) for machining work-pieces (W), which preferably consist, at least in some sections, of wood, wood materials, plastic or the like, comprising: a machining device (B1, B2, B3) for carrying out the workpiece machining, which machining device has a control apparatus having a data transfer interface; and a terminal (10), which has a data transfer interface, which is designed to communicate with the data transfer interface of the machining device (B1, B2, B3) by means of a data connection (15). The control apparatus is designed to forward state information of the machining device (B1, B2, B3) to the terminal (10) via the data transfer interface.

### TECHNICAL FIELD

The invention relates to a system for machining workpieces which preferably consist, at least in some sections, of wood, wood materials, plastic or the like, comprising a machining device for carrying out the workpiece machining, which machining device has a control apparatus having a data transfer interface.

### PRIOR ART

In the furniture and components industry, a wide range of machining devices are used to carry out various machining operations on workpieces. Examples of such machining operations are material-removing machining operations such as, for example, formatting, sawing, milling, drilling or the like, but also coating operations such as the gluing-on of edging or covering materials.

Such machines usually have a machine controller, by means of which the operation of the machining device is controlled on the basis of machining data. The machine controller is usually operated and monitored by an operator. This leads to a considerable amount of non-productive time since, in order to operate and monitor the machine, the operator must be present at the machine controller and is unable to carry out any other activities, or only minor activities.

Furthermore, in the case of machine tools, it is known to relay machine information, such as status messages or error messages, to a terminal via a remote data transfer interface, for example for remote maintenance purposes.

### SUMMARY OF THE INVENTION

The aim of the invention is to provide a system and a method for machining workpieces with improved operating efficiency.

This aim is achieved according to the invention by a system for machining workpieces according to claim 1 and by a method for machining workpieces according to claim 10. Particularly preferred further developments of the invention are specified in the dependent claims.

The invention is based on the concept of spatially uncoupling the operation of a machine tool from the actual machining device. To this end, it is provided according to the invention that, in a system for machining workpieces, the control apparatus is designed to relay status information of the machining device to the terminal via the data transfer interface. In this way, the activity of an operator can be spatially and thus also temporally uncoupled from the operation of the machining device. As a result, the operating efficiency can be considerably increased since the non-productive time or downtime that an operator previously had to spend at a machining device can be drastically reduced.

For example, in order to monitor the machining device, an operator need not be present at the machining device but instead can be remote from and entirely free of the machining device and can carry out other value-adding activities. At the same time, however, the operator can still perform his monitoring activities since status information of the machining device is available on the terminal at all times, for example in the form of a simple display or an active notification or alert.

According to one further development of the invention, it is provided that the system comprises multiple terminals and/or multiple machining devices, each having a data transfer interface. A particularly pronounced increase in production efficiency is achieved as a result. Depending on the design of the system, an operator can be enabled for example to monitor, and optionally also to operate, multiple machining devices simultaneously. In this case, the system may also generate for example a machining order or a prioritization and may display this on the at least one terminal, which leads to further improvements in efficiency. In addition, in this concept, it is also possible to integrate multiple terminals and operators so that, depending on the way in which the system is set up, either a particularly short reaction time is achieved for an operator to react to status information of the system, or else a particularly effective reduction in non-productive time or downtime of the respective operators can be achieved.

Overall, on this basis, a networked whole system involving multiple machining devices and terminals and operators can be implemented, in which a flexible and highly efficient dynamic association of machining devices and operators can be achieved with maximum efficiency.

The at least one terminal may in principle be a stationary terminal which is placed at a suitable location, for example at a location at which an operator can carry out efficiency-increasing activities. Alternatively, according to one further development of the invention, it is provided that at least one terminal is mobile. As a result, the respective operator is given the greatest possible flexibility to perform his activity so that the operator can carry out various efficiency-increasing activities as required. This is also advantageous in particular when multiple machining devices are networked, wherein in this case also one or more machining devices may have a stationary terminal which displays status information relating to one or more other machining devices.

In the case of mobile terminals, it is particularly preferred that the at least one terminal has means for carrying the terminal on the body of an operator, in particular on the arm or in the head region. This enables the at least one terminal to be read and operated effortlessly by the operator, and the operator is also not hindered in his activity, or in other words has his “hands free”.

According to one further development of the invention, it is provided that at least one terminal has information output means which are selected from image output means, sound output means and touch output means, in particular vibration output means. Depending on the particular use, the type of information output means may have particular advantages. For instance, complex issues can best be displayed by an image output means. Sound output means are often suitable for simpler information, but have the advantage that the operator's attention can be attracted more effectively and the operator can, for example, continue his current activity with his eyes and hands. Similar considerations also apply to touch output means, in particular in the case of vibration output means.

The information output means may include one or more of said output means and may be distributed across one or more components. One particularly versatile and highly detailed and easily perceptible way of outputting information is achieved if, according to one further development of the invention, the image output of at least one terminal includes a virtual or projected representation. One example of such an image output may be on a terminal which is worn on the head of a user in the region of the eyes, for example in the manner of so-called “smart glasses”.

In addition, according to one further development of the invention, it is provided that the control apparatus is designed to relay action instructions to the terminal, via the data transfer interface, for output to an operator. This considerably increases the scope of use of the system according to the invention, which is also associated with a significant increase in operating efficiency. For example, the operator is not only able to be notified about error messages or status information, but is also able to receive directly, by means of the system according to the invention, suggested solutions for eliminating the problem in question. By means of the system according to the invention, the operator can also be informed as to which operating steps are necessary in order to duly continue the machining operation, for example inserting new workpieces, replacing consumables, swapping tools or the like. The action instructions can be relayed to the operator by means of the aforementioned information output means in various ways, for example including in the form of GPS data, camera images, virtual representations, projections and various other forms of presentation.

According to one further development of the invention, it is also provided that at least one terminal has information input means. As a result, an interactive system is provided in which the operator is not just a recipient of information, but can also interactively pass information or also instructions or commands back to the system according to the invention. The information input means may for example be touch input means, such as in particular a keyboard or a touchscreen. As an alternative or in addition, however, use can also be made of sound input means, such as speech recognition means for example.

As a further alternative or in addition, use can also be made of motion detection means. Typical motion detection means are gesture detection means, in the case of which the operator can input information into the at least one terminal by simply moving part of his body. Another type of motion detection means is a so-called virtual touchscreen, in which a virtual image is generated or projected in the field of view of the operator and a movement of the user is related to the virtual or projected image in order to effect an information input.

The information input means can in principle be used to transfer any information from at least one terminal to at least one control apparatus. According to one further development of the invention, however, it is provided that at least one control apparatus is designed to receive, via the data transfer interface, control commands for the respective machining device which have been input at at least one terminal by an operator. This further increases the operating efficiency since the operator need not necessarily take himself over to the respective machining device in order to control the machining device.

In order to achieve reliable and trouble-free communication, at least one terminal may advantageously have a wireless data transfer interface, which is based for example on WLAN, Bluetooth or various mobile telephone standards.

The advantages mentioned above can be achieved particularly effectively with the inventive method according to claim 10.

### BRIEF DESCRIPTION OF THE DRAWINGS

FIG. 1 shows a schematic view of one embodiment of the system according to the invention;

FIG. 2 schematically shows another embodiment of the system according to the invention.

### DETAILED DESCRIPTION OF PREFERRED EMBODIMENTS

Preferred embodiments of the invention will be explained in detail below with reference to the accompanying figures. Additional modifications of particular individual features which are mentioned in this connection can each be combined with one another in order to form new embodiments.

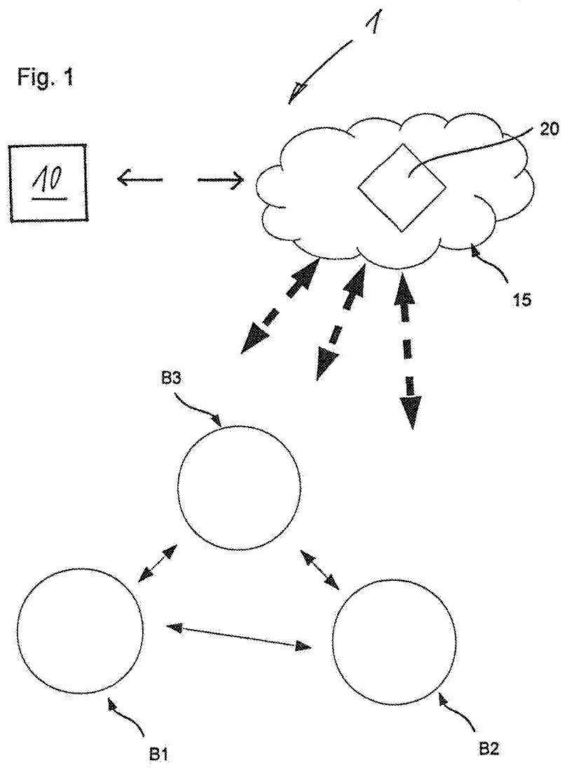

A system 1 for machining workpieces according to one embodiment of the invention is shown schematically in FIG. 1. The system 1 serves for machining a workpiece which consists, at least in some sections, of wood, wood materials, plastic or the like, for example a solid wood panel, a plywood panel, a chipboard panel, an MDF panel, an HDF panel or the like. Such workpieces are preferably used in the furniture and components industry. Purely by way of example, it may be a kitchen worktop, a shelf, a floor panel, door, or the like.

The system 1 in the present embodiment comprises, purely by way of example, three machining devices B1, B2 and B3, each of which serves to carry out a workpiece machining. Each of the machining devices has a control apparatus (not shown) having a data transfer interface.

The system in the present embodiment additionally comprises one terminal 10, although multiple terminals 10 may also be provided. The terminal 10 has a data transfer interface (not shown) which serves and is designed to communicate with the respective data transfer interfaces of the machining devices B1, B2 and B3. The connection takes place by means of a data connection 15, which in the present embodiment is configured as a wireless data connection. The data connection 15 may be configured in the manner of a so-called “cloud” and to this end may optionally also have a dedicated server 20. The wireless data connection itself may be based on various technologies, such as for example WLAN, Bluetooth or a mobile telephone connection.

The control apparatuses of the respective machining devices B1, B2 and B3 are designed to relay status information of the respective machining device to the terminal 10 via the associated data transfer interface. The status information may be a wide variety of information, such as for example the machining status of a workpiece (in particular including the remaining machining time), the operating status or maintenance status of the respective machining device, error messages, or various other status information.

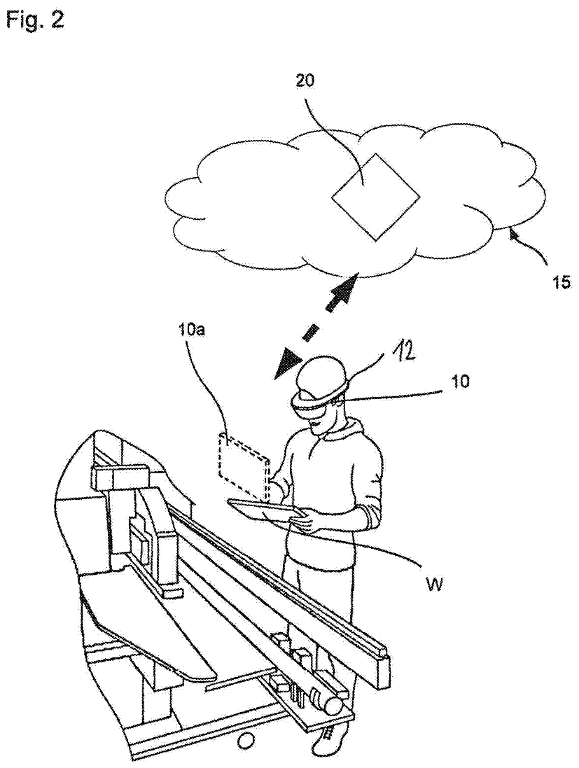

In the present embodiment, the terminal 10 is a mobile terminal which is designed to be worn on the body of an operator. One preferred embodiment of such a terminal 10 is illustrated in FIG. 2, which likewise shows an embodiment of the system according to the invention. In this embodiment, the terminal 10 is configured as so-called smart glasses, which are worn on the head of an operator via a frame 12. Here, the terminal 10 has both an image output and a sound output for relaying information to the operator. In addition, the terminal 10 could also have vibration output means.

In the present embodiment, the image output also includes the outputting of a virtual image 10a, which is shown schematically in FIG. 2. This may be a projected representation which, for example, is actually projected onto a background or optionally also onto a body part of the user. Otherwise, the projected representation may also take place in the smart glasses themselves, but may appear to the user to float freely in space.

The representation of the smart glasses may also take place in the manner of a Virtual Reality or Augmented Reality. In the latter case, reality and virtual representation are presented in a superimposed manner such that they complement one another to form a whole picture.

By virtue of these information output means, the terminal 10 is able to display, in addition to the status information, also further information, such as action instructions in particular, for the respective operator. Such action instructions may be, for example, an operator guide to the machine for various action and set-up activities. To this end, various presentation forms can be displayed on the terminal 10, including camera images, GPS data, virtual representations, projections or the like.

In addition to the aforementioned information output means, the terminal 10 in the present embodiment has various information input means, such as for example a microphone, which may optionally also enable speech recognition, as well as a physical or virtual keyboard or touchscreen. A virtual touchscreen may be based on gesture detection, whereby the operator moves for example one hand into certain areas of the virtual representation 10a and this movement is used to input information.

In this way, not only can the operator be provided with status information for the respective machining device, but the operator can also pass control commands back to the respective machining device. To this end, the control apparatuses of the respective machining devices B1, B2, B3 are designed to receive, via the data transfer interface, control commands which have been input at the at least one terminal 10 by an operator.

The system 1 according to the invention is operated for example as follows. First, an operator, as shown in FIG. 2, carries out a machine operation on a machine tool (for example B1) and, when doing so, follows action instructions which are displayed to the operator by means of the terminal 10 via the virtual representation 10a. By way of example, the operator places a particular workpiece W into the machining device B1. Once this process is complete, the operator confirms this by a virtual input in the virtual representation 10a. The machining device B1 then carries out a machining operation, during which the operator need not intervene for a certain period of time.

The operator can now turn to the machining devices B2 or B3 or also to other activities. The status information of the respective machining devices B1, B2 and B3 is displayed to the operator by means of the terminal 10 so that the operator can decide whether any intervention or actions are currently required on the machining devices.

If no interventions or actions are currently required on the machining devices B1, B2 or B3, the operator can carry out further value-adding activities. However, as soon as measures must be taken on a machining device B1, B2, B3, said measures are displayed to the operator by means of the terminal, or the operator can regularly check that the machining devices are operating properly by means of a status display in the terminal.

To this end, the operator can call up different status views as required. Overall, therefore, this can be referred to as a “production navigation system”, as it were, in which the operator (or optionally multiple operators) has a complete overview of the status of the individual machining devices at all times, and thus also of the system as a whole, by means of the (at least one) terminal 10.

As soon as a machining device requires intervention by the operator, this is displayed to the operator in the terminal 10. Said intervention may be, for example, simply inputting a control command on a machining device, without the operator having to take himself over to the machining device in question. By way of example, the control apparatus of the machining device in question may request, from the operator, approval for a particular machine mode or the next batch of workpieces. As an alternative or in addition, it is also possible that a particular action instruction is displayed to the operator by means of the terminal 10, for example to return to a particular machining device and for example insert new workpieces therein, swap tools, make repairs, etc.

In the context of the present invention, a wide variety of mobile or stationary terminals can be used instead of the smart glasses described above. The range extends from simple headsets (optionally with a microphone and voice control) to highly complex smart devices which can cover the entire range of input and output means.

In addition, the terminal 10 may also have at least one sensor relating to the characteristics of the operator. Various safety and comfort functions can be carried out by means of this at least one sensor, for example detecting fatigue of the operator, but also simply identifying the operator so as to make various operator-specific (comfort) adjustments to the respective machining device based on the recognized operator.

1. System for machining workpieces which consist, at least in some sections, of wood, wood materials, plastic or the like, comprising:
a machining device for carrying out the workpiece machining, which machining device has a control apparatus having a data transfer interface, and
a terminal which has a data transfer interface that is designed to communicate with the data transfer interface of the machining device by means of a data connection, wherein
the control apparatus is designed to relay status information of the machining device to the terminal via the data transfer interface.

2. System according to claim 1, characterized in that it comprises multiple terminals and/or multiple machining devices, each having a data transfer interface.

3. System according to claim 1, characterized in that at least one terminal is mobile and preferably has means for carrying the terminal on the body of an operator, in particular on the arm or in the head region.

4. System according to claim 2, characterized in that at least one terminal has information output means which are selected from image output means, sound output means and touch output means, in particular vibration output means.

5. System according to claim 4, characterized in that the image output of at least one terminal includes a virtual or projected representation.

6. System according to claim 2, characterized in that the control apparatus is designed to relay action instructions to the terminal, via the data transfer interface, for output to an operator.

7. System according to claim 2, characterized in that at least one terminal has information input means which are preferably selected from touch input means, in particular a keyboard or touchscreen, sound input means, in particular speech recognition means, and motion detection means, in particular gesture detection means or a virtual touchscreen.

8. System according to claim 2, characterized in that at least one control apparatus is designed to receive, via the data transfer interface, control commands for the respective machining device which have been input at at least one terminal by an operator.

9. System according to claim 2, characterized in that at least one terminal has a wireless data transfer interface.

10. Method for machining workpieces which consist, at least in some sections, of wood, wood materials, plastic or the like, in particular using a system according to one of the preceding claims, said method comprising the steps:
establishing a data connection between a terminal and a machining device for carrying out the workpiece machining, and
outputting status information of the machining device and/or action instructions by means of the terminal.

11. Method according to claim 10, characterized in that, based on the status information and/or action instruction that is output, an action is performed on the machining device.

12. Method according to claim 11, characterized in that a control command which is input by an operator is relayed from at least one terminal to at least one machining device by means of the data connection.
